(19) United States
(12) Patent Application Publication
(10) Pub. No.: US 2026/0025219 A1
(43) Pub. Date: Jan. 22, 2026

(54) SYSTEM AND METHOD FOR DEVICE INTEGRATION IN A COMBINED CENTRALIZED AND DISTRIBUTED UNIT

(71) Applicant: JIO PLATFORMS LIMITED, Ahmedabad, Gujarat (IN)

(72) Inventors: Narender KUMAR, South Delhi, Delhi (IN); Shakti SINGH, Gurgaon, Haryana (IN); Amrish BANSAL, Navi Mumbai, Maharashtra (IN); Brijesh SHAH, Navi Mumbai, Maharashtra (IN); Bajinder Pal SINGH; Selvakumar -, Tirupur, Tamil Nadu (IN); Pradeep Kumar BHATNAGAR, Navi Mumbai, Maharashtra (IN); Aayush BHATNAGAR

(73) Assignee: JIO PLATFORMS LIMITED, Ahmedabad, Gujarat (IN)

(21) Appl. No.: 18/881,409

(22) PCT Filed: Mar. 7, 2024
(86) PCT No.: PCT/IN2024/050236

§ 371 Date: Jan. 6, 2025

(30) Foreign Application Priority Data
Mar. 31, 2023 (IN) 202321024793

(51) Int. Cl. H04J 3/06

(52) U.S. Cl. CPC H04J 3/0697

(57) ABSTRACT

The disclosed system and method enable providing device integration in a combined centralized and distributed unit (CCDU). Updated CCDU design provides 3× Maximum Receive Unit (MRU (700)) support with a network card (e.g.: Channel Card).

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless networks, and specifically to a system and method for providing device integration in a Combined Centralized and Distributed Unit (CCDU).

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Fifth generation (5G) technology is expected to fundamentally transform the role that telecommunications technology plays in industry and society at large. A gNodeB (gNB) is an implementation of a 5G-NR base station. It consists of independent network functions, which implement New Radio (NR) Radio Access Network (RAN) protocols namely: Physical Layer (PHY), Media Access Control Layer (MAC), Radio Link Control (RLC), Packet Data Convergence Protocol (PDCP), Service Data Adaptation Protocol (SDAP), Radio Resource Control (RRC), Network Real-time Analysis Platform (NRAP). The gNB further incorporates three functional modules: Centralized Unit (CU), Decentralized Unit (DU) and Radio Unit (RU), which can be deployed in multiple combinations. They can run together or independently and can be deployed on either physical (e.g. a small cell chipset) or virtual resources (e.g. dedicated Commercial Off The Shelf (COTS) server or shared cloud resources). The CU provides support for higher layers of protocol stack such as Service Data Adaption Protocol (SDAP), Packet Data Convergence Protocol (PDCP) and the RRC, while the DU provides support for lower layers of the protocol stack such as the RLC, the MAC and the physical layer. In a 5G RAN architecture, the DU in the baseband unit (BBU) is responsible for real time Layer 1 and Layer 2 scheduling functions of the 5G protocol stack layer, and the CU is responsible for non-real time, higher L2 and L3 of the 5G protocol stack layer.

Existing Combined Centralized and Distributed Unit (CCDU) solutions has a few shortcomings and only provides limited support for 3*3.5 GHz Maximum Receive Unit (MRU). In addition, a number of ports provided for being used with an external low cost NIC card, and plugin for the PCIe slot available on the CCDU do not support any external synchronization through clock.

There is, therefore, a need in the art for an improved system and method to provide an advanced CCDU that provides extra ports for supporting additional MRU.

### SUMMARY

In an exemplary embodiment, a system for device integration in a combined centralized and distributed unit (CCDU) is described. The system is configured to provide a maximum receive unit (MRU) with the CCDU connected with a network channel using a back-to-back connection over a backhaul port. The system is further configured to synchronize the MRU with a physical hardware clock (PHC) of a plurality of ethernet controllers and PHC of a network card using a clock generated by a global positioning system (GPS).

In some embodiments, the system for synchronizing of the MRU with the PHC of the plurality of ethernet controllers and PHC of a network card comprising providing, by the GPS, one pulse-per-second signal (1PPS) clock along with a time of day (ToD) through a national marine electronics association (NMEA) packets. A network synchronizer is used along with on board oven-controlled crystal oscillators (OCXO). The system further comprising providing, by the network synchronizer, the main clock of 156.25 MHz and the 1PPS clock to a first ethernet controller and a second ethernet controller of the plurality of ethernet controllers and generating, by PHC of the first ethernet controller, plurality of precision time protocol (PTP) time stamps using 1PPS from the network synchronizer and ToD from the NMEA packet. The PHC of the first ethernet controller of the plurality of ethernet controllers is synchronized with TS2PHC.

In some embodiments, the system for synchronizing of the MRU with the PHC of the plurality of ethernet controllers and PHC of a network card further comprising synchronizing a system clock with PHC of first ethernet controller of the plurality of ethernet controllers and providing, by a PTP master, the plurality of PTP time stamps to the MRU, wherein the PTP master is run on all three ports. The system further comprising running, by the MRU, a PTP slave to recover clock and time from plurality of PTP time stamps received from the CCDU for achieving synchronization in all 3×MRU of 3.5 GHz. The 3×MRU is connected on the network card and a link from the second ethernet controller port 0 to network card port 0 is made using 1G small form factor pluggable (SFP) and cable.

In some embodiments, the system for synchronizing of the MRU with the PHC of the plurality of ethernet controllers and PHC of a network card further comprising synchronizing PHC of the second ethernet controller using the TS2PHC generic with system ToD and 1PPS from the GPS and passing time stamps to PHC of network card by running the PTP Master on the second ethernet controller port 0 and the PTP slave on the network card port 0. The PHC of network card is in sync with the PHC of the second ethernet controller. The system further comprising running the PTP master on the network card 3 ports to the MRU and getting the ToD and clock by running the PTP slave in the MRU.

In some embodiments, if the GPS is absent, filtering out jitter in the 1PPS and providing a holdover clock.

In another exemplary embodiment, a method for device integration in a combined centralized and distributed unit (CCDU) is described. The method comprising providing a maximum receive unit (MRU) with the CCDU connected with a network channel using a back-to-back connection over a backhaul port. The method further comprising synchronizing the MRU with a physical hardware clock (PHC) of a plurality of ethernet controllers and PHC of a network card using a clock generated by a global positioning system (GPS).

In some embodiments, the method for synchronizing of the MRU with the PHC of the plurality of ethernet controllers and PHC of a network card comprising providing, by the GPS, one pulse-per-second signal (1PPS) clock along with a time of day (ToD) through a national marine electronics association (NMEA) packets. A network synchronizer is used along with on board oven-controlled crystal oscillators (OCXO). The method further comprising providing, by the network synchronizer, the main clock of 156.25 MHz and the 1PPS clock to a first ethernet controller and a second ethernet controller of the plurality of ethernet controllers and generating, by PHC of the first ethernet controller, plurality of precision time protocol (PTP) time stamps using 1PPS from the network synchronizer and ToD from the NMEA packet. The PHC of the first ethernet controller of the plurality of ethernet controllers is synchronized with TS2PHC.

In some embodiments, the method for synchronizing of the MRU with the PHC of the plurality of ethernet controllers and PHC of a network card further comprising synchronizing a system clock with PHC of first ethernet controller of the plurality of ethernet controllers and providing, by a PTP master, the plurality of PTP time stamps to the MRU, wherein the PTP master is run on all three ports. The method further comprising running, by the MRU, a PTP slave to recover clock and time from plurality of PTP time stamps received from the CCDU for achieving synchronization in all 3×MRU of 3.5 GHz. The 3×MRU is connected on the network card and a link from the second ethernet controller port 0 to network card port 0 is made using 1G small form factor pluggable (SFP) and cable.

In some embodiments, the method for synchronizing of the MRU with the PHC of the plurality of ethernet controllers and PHC of a network card further comprising synchronizing PHC of the second ethernet controller using the TS2PHC generic with system ToD and 1PPS from the GPS and passing time stamps to PHC of network card by running the PTP Master on the second ethernet controller port 0 and the PTP slave on the network card port 0. The PHC of network card is in sync with the PHC of the second ethernet controller. The method further comprising running the PTP master on the network card 3 ports to the MRU and getting the ToD and clock by running the PTP slave in the MRU.

In some embodiments, if the GPS is absent, filtering out jitter in the 1PPS and providing a holdover clock.

The foregoing general description of the illustrative embodiments and the following detailed description thereof are merely exemplary aspects of the teachings of this disclosure, and are not restrictive.

### OBJECTS OF THE PRESENT DISCLOSURE

It is an object of the present disclosure to provide a system and method for device integration in a combined centralized and distributed unit (CCDU).

It is an object of the present disclosure to provide an updated and improved CCDU design for 3× massive Maximum Receive Unit (MRU) 700 support with a network card.

It is an object of the present disclosure to provide a synchronized MRU 700 with the CCDU connected with a network card using a back to back connection over a backhaul port.

It is an object of the present disclosure to provide a system that can operate over Wide temperature range.

It is an object of the present disclosure to provide a system that operates at standard telecom power supply (−48 VDC) with all required protection for telecom sites.

It is an object of the present invention to integrate and synchronize the MRU 700 with the CCDU connected with the network card using a back to back connection over backhaul ports.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary representation of a network card in a boundary clock mode, in accordance with an embodiment of the disclosure.

FIG. 2 illustrates synchronization of Maximum Receive Unit (MRU) 700 with other devices in a clock, in accordance with an embodiment of the disclosure.

FIG. 3 illustrates a descriptive flow for synchronization of the MRU 700 with other devices in a clock, in accordance with an embodiment of the disclosure.

FIG. 4 illustrates an exemplary Combined Centralized and Distributed Unit (CCDU) setup for network card boundary clock arrangement, in accordance with an embodiment of the disclosure.

FIG. 5 illustrates an exemplary computer system in which or with which embodiments of the present disclosure may be implemented.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The disclosed system and method provides device integration in a combined centralized and distributed unit (CCDU). Updated CCDU design provides 3X Maximum Receive Unit (MRU) 700 support with a network card (e.g., channel card).

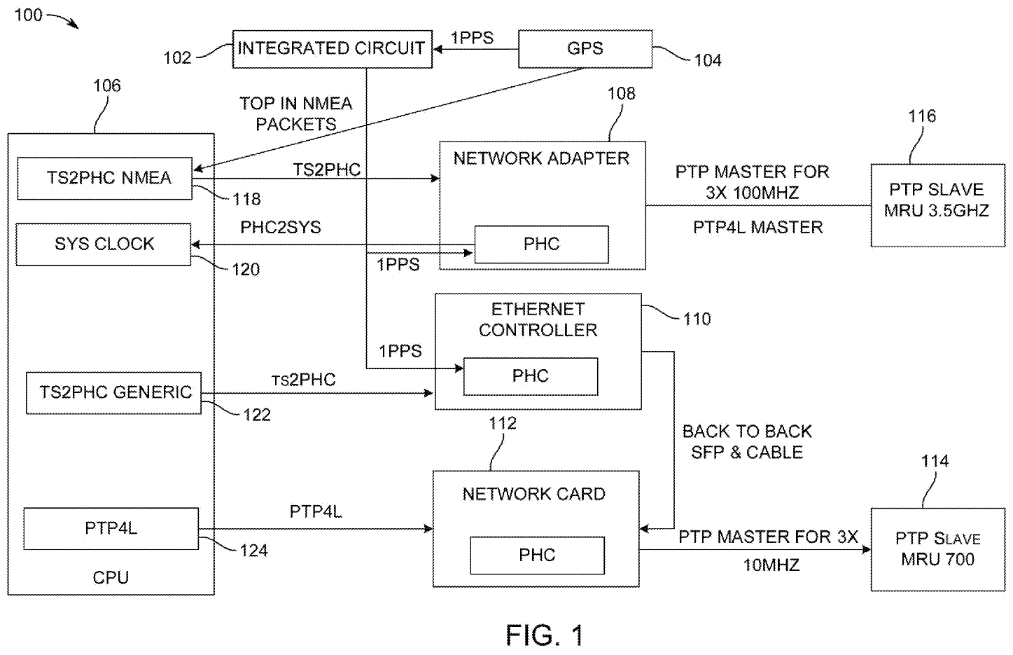

FIG. 1 illustrates an exemplary representation (100) of the network card in a boundary clock mode in the CCDU, in accordance with an embodiment of the disclosure. A global positioning system (GPS) (104) may be in communication with a central processing unit (CPU) (106) and an integrated circuit (102). The CPU (106) may include TS2PHC NMEA (118), a system clock (sys clock) (120), TS2PHC generic (122) and PTP4L (1). TS2PHC may refer to Time Stamp to Pulse per Half Cycle. NMEA (National Marine Electronics Association) is a standard for communication between marine electronic devices. TS2PHC NMEA (118) may refer to a format or protocol used to timestamp pulses based on the NMEA standard for applications that require precise time synchronization. TS2PHC generic (122) may refer to a generic implementation or usage of the TS2PHC concept, which is the timestamping of pulses based on the Pulse per Half Cycle principle. It may not be specific to any particular industry or protocol and can be applied in various applications where accurate timing synchronization is required. PTP4L (124) refers to Precision Time Protocol (PTP) for Linux. It is an open-source software implementation of the PTP protocol for accurate time synchronization in Linux-based systems. PTP4L (124) enables the synchronization of clocks across a network by exchanging timing information between PTP devices. In the Precision Time Protocol (PTP) system, a PTP master is a device or node that serves as the primary time reference for synchronization on a network. It typically has a highly accurate clock and is responsible for distributing timing information to other devices in the network. A PTP grandmaster is the highest-level time synchronization source in a PTP network hierarchy. It is the ultimate source of timing information and serves as the master clock for the entire network. PTP grandmasters are typically equipped with highly precise clocks and are responsible for providing accurate time synchronization to all devices within the network. PTP slave: A PTP slave is a device or node in a PTP network that synchronizes its clock to the timing information provided by a PTP master or grandmaster. PTP slaves adjust their clock frequency and phase to align with the master clock, ensuring accurate time synchronization throughout the network. In an aspect, a national marine electronics association (NMEA) is a standard data format supported by all GPS. The CPU (106) may be in communication with on board network adapter (108), ethernet controller (110) and network card (112). The integrated circuit (102) may be in communication with the on-board network adapter (108) and the ethernet controller (110). The ethernet controller (110) may be in communication with the network card (112). The on-board network adapter (108) may be in communication with a precision time protocol (PTP) SLAVE MRU 3.5 GHZ (116). The network card may be in communication with PTP SLAVE MRU 700 (114). In an aspect, the PTP may use to synchronize clocks throughout the network.

The GPS (104) may send 1PPS to the integrated circuit (102) and Time of Day (ToD) to the CPU (106). The TS2PHC NMEA (118) may send TS2PHC to the on-board network adapter (108). PHC of the on-board network adapter (108) may send PHC2SYS to the SYS clock. TS2PHC generic (122) may send TS2PHC to the PHC of ethernet controller (110). The PTP4L (124) may send PTP4L to the network card (112).

The integrated circuit (102) may send 1PPS to the PHC of on-board network adapter (108) and the PHC of the ethernet controller (110). The ethernet controller (110) may send a back-to-back Small Form Factor Pluggable (SFP) and cable to the network card (112).

The on-board network adapter (108) may send a PTP master for 3×100 MHz and PTP4L master to the PTP SLAVE MRU 3.5 GHZ (116). The network card (112) may send a PTP master for 3×10 MHz to the PTP SLAVE MRU 700 (114).

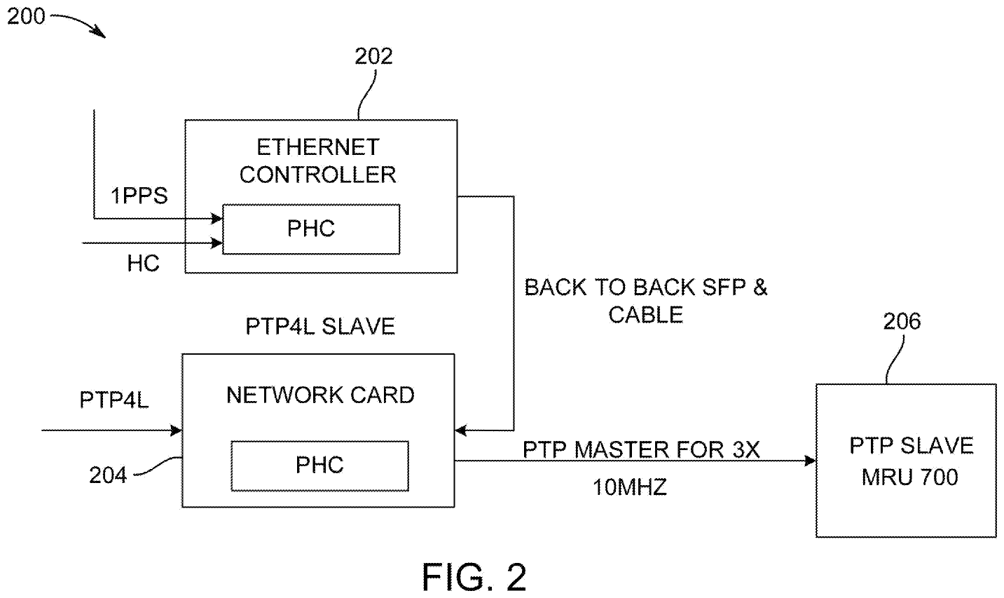

FIG. 2 illustrates, at 200, a synchronization of MRU 700 with other devices in a clock, in accordance with an embodiment of the disclosure. As is illustrated, Ethernet controller (202) is made as a master device and shall generate Precision Time Protocol (PTP) packets. The generated PTP packets shall pass on to the network card. Furthermore, the network card (204) may act as a slave. With this master-slave relation, Physical Hardware Clock (PHC) of the network card will be in sync with the PHC of the ethernet controller (202).

The network card (204) shall now be made as master, and the PTP at MRU 700 (206) may act as a slave. Henceforth, the MRU 700 (206) may get synchronized with the network card (204) PHC (master). With this, all components shall be in synchronized state against the clock generated by the GPS. The synchronizer shall receive a clock from the GPS and may be used in the entire system. As may be noted, delay obtained because of clock sync is within acceptable limits, i.e. 250 Nano second (achieving 10 Nano second delay). Hence, with this sync procedure, the CCDU may be capable of handling additional 3 MRU 700 MHz.

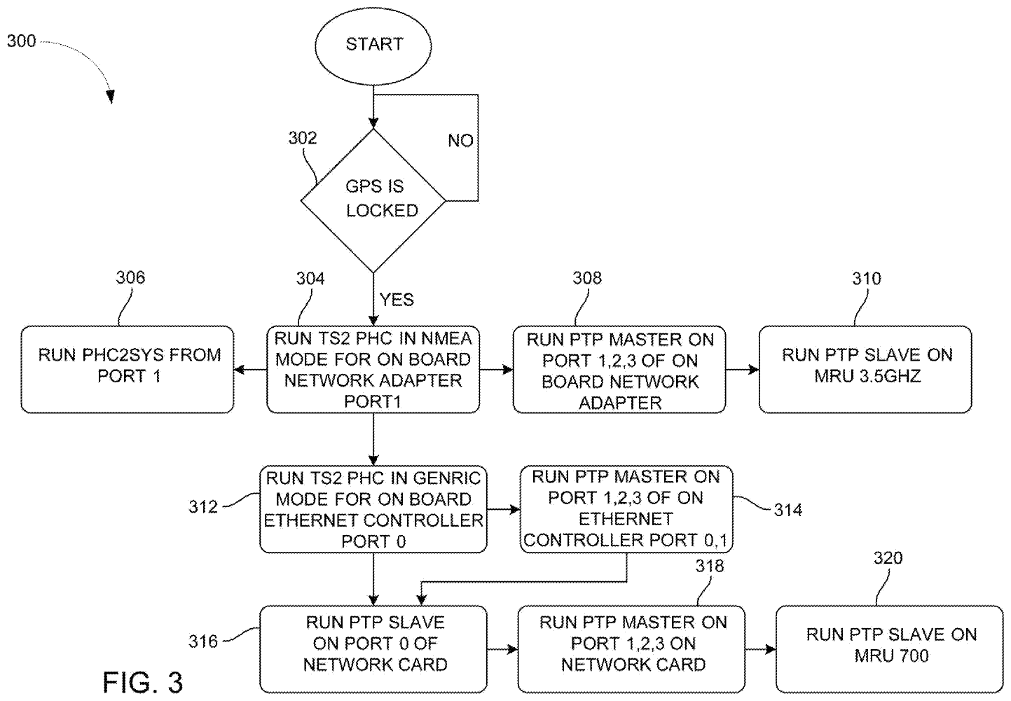

FIG. 3 illustrates a descriptive flow 300 for synchronization of MRU 700 with other devices in a clock, in accordance with an embodiment of the disclosure. As is illustrated, At step 302, Global Positioning System (GPS) is a main source of synchronization across all Next Generation Node B (gNB). It provides one pulse-per-second signal (1PPS) clock along with Time of Day (ToD) through National Marine Electronics Association (NMEA) packets.

At step 304, Jitter is filtered out in the 1PPS, and a holdover clock is provided in case if the GPS is absent, integrated circuit is used along with on board Oven-controlled crystal oscillators (OCXO). In an aspect, OCXO may be a quartz-based timing device (clock) utilized in precision timing. Integrated circuit provides both the main clock of 156.25 MHz and the 1PPS clock to network adapter-CAM1 and ethernet controller both. CAM1 PCH is synchronized with ts2Phc utility, which uses 1PPS from integrated circuit and ToD from the NMEA packet to generate Precision Time Protocol (PTP) time stamps.

At step 306, System clock gets sync with help of phc2sys with synchronized system clock with CAM1 PHC.

At step 308, PTP master is run on all three ports to provide timestamps to MRU.

At step 310, MRU runs PTP slave to recover clock and time from timestamps received from CCDU CAM1 and hence synchronization is achieved in all 3×MRU of 3.5 GHz.

At step 312, Since the 3×MRU of 700 MHz is connected on network card, a link from the ethernet controller port 0 to the network card port 0 is made using 1G SFP and cable. In an aspect, the SFP may be a network interface module used for both telecommunication and data communications applications. The SFP may be a transceiver (a transmitter and receiver), which enables data transmission between two devices. The ethernet controller PHC is synced using ts2phc generic with system ToD and 1PPS from the GPS.

At step 314, PTP Master is run on the ethernet controller port 0.

At step 316, the slave is run on network card port 0 to pass time stamps to network card PHC.

At step 318, the PHC of network card is in sync with the PHC of the ethernet controller. The PTP Master is run on network card 3 ports to provide time stamps further to MRU 700.

At step 320, the PTP slave is run in MRU 700 to get the ToD and clock.

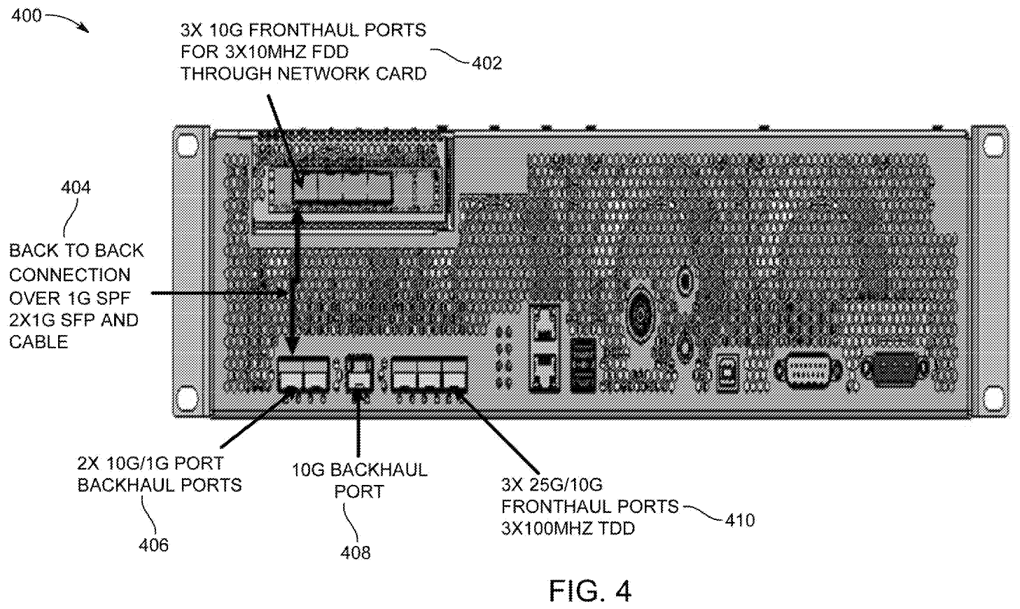

FIG. 4 illustrates an exemplary CCDU setup 400 for boundary clock arrangement, in accordance with an embodiment of the disclosure. As is illustrated, the setup includes a 3λ10G fronthaul port (402) for 3λ10GMHz FDD through x. Further, a back-to-back connection over 1G SFP, 2×1GSFP and cable (404) is provided. Also provided are 2×10G/1G port backhaul ports (406), 10G backhaul port (408) and 3×25G/10G fronthaul ports and 3×100 MHz TDD (410).

The disclosed system and method provide a synchronized MRU 700 with the CCDU connected with the network card using a back-to-back connection over backhaul ports. The back-to-back connection over backhaul ports may refer to a direct link between two devices or systems using a dedicated backhaul port. This connection may be used for high-speed data transmission or communication between devices, such as network switches or routers, over a backhaul network. The backhaul port may allow for efficient and reliable transfer of data between the connected devices, enabling seamless communication and optimal performance. Also, disclosed is a procedure of synchronization of the CCDU that is extended to MRU 700.

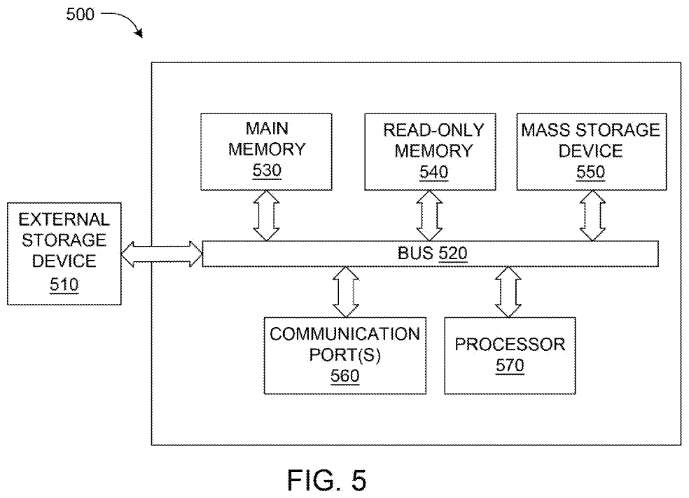

FIG. 5 illustrates an exemplary computer system 500 in which or with which embodiments of the present disclosure may be implemented. As shown in FIG. 5, the computer system 500 may include an external storage device 510, a bus 520, a main memory 530, a read-only memory 540, a mass storage device 550, communication port(s) 560, and a processor 570. A person skilled in the art will appreciate that the computer system 500 may include more than one processor and communication ports. The processor 570 may include various modules associated with embodiments of the present disclosure. The communication port(s) 560 may be any of an RS-232 port for use with a modem-based dialup connection, a 10/100 Ethernet port, a Gigabit or 10 Gigabit port using copper or fiber, a serial port, a parallel port, or other existing or future ports. The communication port(s) 560 may be chosen depending on a network, such a Local Area Network (LAN), Wide Area Network (WAN), or any network to which the computer system 500 connects.

The main memory 530 may be random access memory (RAM), or any other dynamic storage device commonly known in the art. The read-only memory 540 may be any static storage device(s) e.g., but not limited to, a Programmable Read Only Memory (PROM) chips for storing static information e.g., start-up or Basic Input/Output System (BIOS) instructions for the processor 570. The mass storage device 550 may be any current or future mass storage solution, which can be used to store information and/or instructions. Exemplary mass storage device 550 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 520 communicatively couples the processor 570 with the other memory, storage, and communication blocks. The bus 520 may be, e.g. a Peripheral Component Interconnect (PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor 570 to the computer system 500.

Optionally, operator and administrative interfaces, e.g. a display, keyboard, joystick, and a cursor control device, may also be coupled to the bus 520 to support direct operator interaction with the computer system 500. Other operator and administrative interfaces can be provided through network connections connected through the communication port(s) 560. Components described above are meant only to exemplify various possibilities. In no way should the aforementioned exemplary computer system 500 limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a system and a method for device integration in a combined centralized and distributed unit (CCDU).

The present disclosure provides an updated and improved CCDU design for 3× massive Maximum Receive Unit (MRU) 700 supports with a network card.

The present disclosure provides a synchronized MRU 700 with the CCDU connected with salem channel using a back-to-back connection over a backhaul port.

The present disclosure provides a system in a single unit to reduce cost and increase reliability with higher configuration.

The present disclosure provides a hardware design that is on a single Printed Circuit Board (PCB) approach by keeping all required SoC on board.

The present disclosure provides a system that operates over wide temperature range.

The present disclosure provides an integrated unit with reduced number of interfaces.

The present disclosure provides a system that supports required synchronization such as Global Positioning System (GPS), Precision Time Protocol (PTP) and holdover.

The present disclosure provides a system that facilitates site alarms over dry contacts to equip with external alarm device.

The present disclosure provides a system that is efficient in performance of Centralized Unit (CU) and Decentralized Unit (DU) functionalities.

The present disclosure provides a system that operates at a standard telecom power supply (−48 VDC) with all required protection for telecom sites.

The present disclosure provides a system that is easily deployed on server racks.

The present disclosure provides a system that has low power consumption and is thermally handed properly by IP65 ingress protected mechanical housing.

We claim:

1. A system for device integration in a combined centralized and distributed unit (CCDU) is configured to:
provide a maximum receive unit (MRU (700)) (114) with the CCDU connected with a network channel using a back-to-back connection over a backhaul port; and
synchronize the MRU (700) (114) with a physical hardware clock (PHC) of a plurality of ethernet controllers (110) and PHC of a network card (112) using a clock generated by a global positioning system (GPS) (104).

2. The system as claimed in claim 1, synchronizing of the MRU (700) (114) with the PHC of the plurality of ethernet controllers and PHC of the network card comprising:
providing, by the GPS (104), one pulse-per-second signal (1PPS) clock along with a time of day (ToD) through a national marine electronics association (NMEA) packets;
using a network synchronizer along with on board oven-controlled crystal oscillators (OCXO);
providing, by the network synchronizer, the main clock of 156.25 MHz and the 1PPS clock to a first ethernet controller and a second ethernet controller of the plurality of ethernet controllers; and
generating, by PHC of the first ethernet controller, plurality of precision time protocol (PTP) time stamps using 1PPS from the network synchronizer and ToD from the NMEA packet, wherein PHC of the first ethernet controller of the plurality of ethernet controllers is synchronized with TS2PHC.

3. The system as claimed in claim 1, synchronizing of the MRU (700) (114) with the PHC of the plurality of ethernet controllers (110) and PHC of the network card (112) further comprising:
synchronizing a system clock (120) with PHC of first ethernet controller of the plurality of ethernet controllers;
providing, by a PTP master, a plurality of PTP time stamps to the MRU (700), wherein the PTP master is run on all three ports; and
running, by the MRU (700) (104), a PTP slave to recover clock and time from plurality of PTP time stamps received from the CCDU for achieving synchronization in all 3×MRU (700) of 3.5 GHz, wherein the 3×MRU is connected on the network card and a link from the second ethernet controller port 0 to network card port 0 is made using 1G small form factor pluggable (SFP) and cable.

4. The system as claimed in claim 1, synchronizing of the MRU (700) (114) with the PHC of the plurality of ethernet controllers (110) and PHC of the network card (112) further comprising:
synchronizing PHC of the second ethernet controller using a program with system ToD and 1PPS from the GPS (104);
passing time stamps to PHC of network card (112) by running the PTP Master on the second ethernet controller port 0 and the PTP slave on the network card port 0, wherein the PHC of network card (112) is in sync with the PHC of the second ethernet controller;
running the PTP master on the network card 3 ports to the MRU (700) (114); and
getting the ToD and clock by running the PTP slave in the MRU (700) (114).

5. The system as claimed in claim 1, wherein if the GPS (104) is absent,
filtering out jitter in the 1PPS; and
providing, a holdover clock.

6. A method for device integration in a combined centralized and distributed unit (CCDU) comprising:
providing a maximum receive unit (MRU (700)) (114) with the CCDU connected with a network channel using a back-to-back connection over a backhaul port; and
synchronizing the MRU (700) (114) with a physical hardware clock (PHC) of a plurality of ethernet controllers (110) and PHC of a network card (112) using a clock generated by a global positioning system (GPS) (104).

7. The method as claimed in claim 6, synchronizing of the MRU (700) (114) with the PHC of the plurality of ethernet controllers and PHC of the network card comprising:
providing, by the GPS (104), one pulse-per-second signal (1PPS) clock along with a time of day (ToD) through a national marine electronics association (NMEA) packets;
using a network synchronizer along with on board oven-controlled crystal oscillators (OCXO);
providing, by the network synchronizer, the main clock of 156.25 MHz and the 1PPS clock to a first ethernet controller and a second ethernet controller of the plurality of ethernet controllers; and
generating, by PHC of the first ethernet controller, plurality of precision time protocol (PTP) time stamps using 1PPS from the network synchronizer and ToD from the NMEA packet, wherein PHC of the first ethernet controller of the plurality of ethernet controllers is synchronized with TS2PHC.

8. The method as claimed in claim 6, synchronizing of the MRU (700) (114) with the PHC of the plurality of ethernet controllers (110) and PHC of the network card (112) further comprising:
synchronizing a system clock (120) with PHC of first ethernet controller of the plurality of ethernet controllers;
providing, by a PTP master, a plurality of PTP time stamps to the MRU (700), wherein the PTP master is run on all three ports; and
running, by the MRU (700) (104), a PTP slave to recover clock and time from plurality of PTP time stamps received from the CCDU for achieving synchronization in all 3×MRU of 3.5 GHz, wherein the 3×MRU is connected on the network card and a link from the second ethernet controller port 0 to network card port 0 is made using 1G small form factor pluggable (SFP) and cable.

9. The method as claimed in claim 6, synchronizing of the MRU (700) (114) with the PHC of the plurality of ethernet controllers (110) and PHC of the network card (112) further comprising:
synchronizing PHC of the second ethernet controller using a program with system ToD and 1PPS from the GPS (104);
passing time stamps to PHC of network card (112) by running the PTP Master on the second ethernet controller port 0 and the PTP slave on the network card port 0, wherein the PHC of network card (112) is in sync with the PHC of the second ethernet controller;
running the PTP master on the network card 3 ports to the MRU (700) (114); and
getting the ToD and clock by running the PTP slave in the MRU (700) (114).

10. The method as claimed in claim 6, wherein if the GPS (104) is absent:
filtering out jitter in the 1PPS; and
providing, a holdover clock.

11. A computer program product comprising a non-transitory computer-readable medium comprising instructions that, when executed by one or more processors, cause the one or more processors to perform method for device integration in a combined centralized and distributed unit (CCDU) comprising:
providing a maximum receive unit (MRU (700)) (114) with the CCDU connected with a network channel using a back-to-back connection over a backhaul port; and
synchronizing the MRU (700) (114) with a physical hardware clock (PHC) of a plurality of ethernet controllers (110) and PHC of a network card (112) using a clock generated by a global positioning system (GPS) (104).
